(19) United States
(12) Patent Application Publication
(10) Pub. No.: US 2015/0264491 A1
(43) Pub. Date: Sep. 17, 2015

(54) DEVICE FOR INSERTING OR WITHDRAWING A HEARING AID

(71) Applicant: Oticon A/S, Smorum (DK)

(72) Inventors: Lars Ivar HAUSCHULTZ, Valby (DK); Henning Knak POULSEN, Roskilde (DK)

(73) Assignee: OTICON A/S, Smorum (DK)

(21) Appl. No.: 14/658,952

(22) Filed: Mar. 16, 2015

(30) Foreign Application Priority Data
Mar. 17, 2014 (EP) 14160247.4

(51) Int. Cl. H04R 25/00; H04R 1/10

(52) U.S. Cl. CPC H04R 25/00; H04R 1/10; H04R 2225/025

(57) ABSTRACT

According to an embodiment of the disclosure, a device for inserting a hearing aid into an ear canal of a user of the hearing aid or for withdrawing the hearing aid from the ear canal is disclosed. The device includes a tool adapted to removably attach to the hearing aid for positioning the hearing aid in the ear canal, a camera adapted to capture data comprising at least one image and/or video of the ear canal during the insertion or withdrawing of the hearing aid; and a transmitter adapted to transmit the captured data to an external unit.

### FIELD

The disclosure relates to inserting a hearing aid into an ear canal and withdrawing the hearing aid from the ear canal. In particular, the disclosure relates to a device and a tool individually adapted to assist in inserting the hearing aid into the ear canal and withdrawing the hearing aid from the ear canal.

### DESCRIPTION OF RELATED ART

There exist various types of hearing aids adapted to make speech more intelligible, and to correct impaired hearing. Some of these hearing aids are small sized and adapted to be fully or partly inserted into the ear canal of a user. This group of hearing aids typically includes in-the-ear (ITE) hearing aids, invisible-in-canal (IIC) hearing aids and completely-in-canal (CIC) hearing aids, which are small and aesthetically more acceptable hearing aids.

CIC hearing aids may almost not be seen from outside. Accordingly, no one notices that the user is wearing the CIC hearing aid. The CIC hearing aids represent one of the smallest model in hearing aids and such hearing aids are usually suitable for people having mild to moderate hearing loss. The CIC hearing aid may include a custom-made shell containing all the electronic components or it may comprise a faceplate part facing towards the ear canal opening whereto, facing into the ear canal, electronic components in an enclosure is provided. In this type of CIC, the receiver may be sitting deeper in the canal, comprise a dome sealing the area between the receiver opening and the ear canal wall, and be attached to the faceplate by a flexible extension. The shell or faceplate needs to be placed deeply in the ear canal, making the hearing aid almost invisible.

Furthermore, hearing aids that reside deep-in-the-canal (DIC) offer major step forward in terms of sound quality, invisibility from an external perspective, and may reside in place for a period of several months, the residence time limit determined, in major part, by the lifetime of the battery. Typically, DIC hearing aids are placed deep in the ear canal, in the bony portion of the canal very near the tympanic membrane, and may reside in that site for several months. A major factor limiting residence time is the lifetime of the battery, and as improvements in batteries extend their life, so too will lengthen the residence time of DIC hearing aids.

During insertion of these hearing aids, special instruments are usually required. Prior to insertion, one needs to provide an attachment between the instrument and the hearing aid. The instrument allows for placing the hearing aid in the ear canal. When the hearing aid is arranged in the desired position in the ear canal of the user, the instrument is detached from the hearing aid and removed from the ear canal. One such prior art instrument is known from EP 2355552.

The available instruments are neither easy to attach nor easy to detach but the absence of any additional guidance in these instruments make the insertion/withdrawal steps rather challenging. Further challenges include difficulty in handling a small hearing aid device in constrained space of the ear canal and placing the hearing aid in a desired position, i.e. neither dangerously deep into the ear canal threatening integrity of the tympanic membrane nor too far away from the tympanic membrane making the hearing aid perform sub-optimally. For example, it is desirable to insert the hearing aid deeply into the ear canal of the user for several reasons including cosmetic appeal and improved sound fidelity.

Accordingly, there is a need for an improved device and a tool that overcomes the above-mentioned shortcomings and allows for assisting in inserting the hearing aid into the ear canal and withdrawing the hearing aid from the ear canal.

### SUMMARY

The object of the disclosure is achieved by a device as defined in claim 1 and by a tool as recited in the independent claim of the tool. Preferred embodiments are defined in the dependent sub claims and explained in the following description and illustrated in the accompanying drawings.

According to an embodiment of the disclosure, a device for inserting a hearing aid into an ear canal of a user of the hearing aid or for withdrawing the hearing aid from the ear canal is disclosed. The device includes a tool adapted to removably attach to the hearing aid for positioning the hearing aid in the ear canal, a camera adapted to capture data comprising at least one image and/or video of the ear canal during the insertion or withdrawing of the hearing aid; and a transmitter adapted to transmit the captured data to an external unit.

The device is a remote control device or made as a part of a remote control unit. The remote control is handheld by the user, the remote control device being portable. The remote control typically comprises a wireless communication means for communicating the captured data with other devices such as a display unit. However, wired communication means may also be used.

According to another embodiment of the disclosure, a tool for inserting a hearing aid into an ear canal of a user of a hearing aid and for withdrawing the hearing aid from the ear canal is disclosed. The tool includes an activation means adapted to actuate an attachment means for removably attaching the tool to the hearing aid through electroadhesion.

### BRIEF DESCRIPTION OF THE ACCOMPANYING DRAWINGS

The embodiments of the disclosure, together with its advantages, may be best understood from the following detailed description taken in conjunction with the accompanying figures, which are given by way of illustration only, and thus, they are not limiting the disclosure. In the accompanying drawings:

FIG. 1a) illustrates schematically a view of the hearing aid being inserted into the ear canal of the user by using the tool comprised by a device according to an embodiment of the disclosure;

FIG. 1b) illustrates a schematically perspective view of the device with the tool at an extended position according to an embodiment of the disclosure;

FIG. 1c) illustrates a schematically perspective view of the device with the tool in an enclosed position according to an embodiment of the disclosure;

FIG. 2a) illustrates schematically a view of a hearing aid being inserted into the ear canal of the user by using the tool according to an embodiment of the disclosure;

FIG. 2b) illustrates schematically a cross-sectional view of the tool being attached to the hearing aid according to an embodiment of the disclosure;

FIG. 2c) illustrates schematically a cross sectional view of the tool being attached to the hearing aid according to an embodiment of the disclosure;

FIG. 3 schematically a view of the hearing aid being inserted into the ear canal of the user by means of the tool comprised by the device, while images and/or a video captured by the camera are sent to the external unit according to an embodiment of the disclosure;

FIG. 4a) illustrates how the tool is attached to the hearing aid according to an embodiment of the disclosure;

FIG. 4b) illustrates how the tool is detached from the hearing aid according to an embodiment of the disclosure;

FIG. 4c) illustrates a through-going bore according to an embodiment of the disclosure;

FIG. 4d) illustrates an ear lens type hearing aid according to an embodiment of the disclosure;

FIG. 5a) illustrates a schematically cross-sectional view of a proximal portion of the tool according to an embodiment of the disclosure;

FIG. 5b) illustrates a close-up view of the tool shown in FIG. 5a) arranged next to a hearing aid according to an embodiment of the disclosure; and

FIG. 5c) illustrates a close-up view of the tool shown in FIG. 5a) being attached the hearing aid according to an embodiment of the disclosure.

### DETAILED DESCRIPTION

A hearing aid refers to an apparatus such as e.g. a hearing device, a listening device or an ear-protection device. These devices are typically used to augment and/or improve hearing capabilities of a user by receiving acoustic signals from the user's surroundings or receiving audio signal electronically, generating corresponding audio signals, possibly modifying the audio signals and providing the possibly modified audio signals as audible signals to at least one of the user's ears. A hearing aid may comprise a single unit or several units communicating electronically with each other.

More generally, a hearing aid comprises an input transducer for receiving an acoustic signal from a user's surroundings and providing a corresponding input audio signal and/or a receiver for electronically receiving an input audio signal, a signal processing circuit for processing the input audio signal and an output means for providing an audible signal to the user in dependence on the processed audio signal. Some hearing aids may comprise multiple input transducers, e.g. for providing direction-dependent audio signal processing. In some hearing aids, the receiver may be a wireless receiver. In some hearing aids, the receiver may be e.g. an input amplifier for receiving a wired signal. In some hearing aids, an amplifier may constitute the signal processing circuit. In some hearing aids, the output means may comprise an output transducer, such as e.g. a loudspeaker for providing an air-borne acoustic signal.

The hearing aid may be a hearing system referring to a system comprising one or two hearing aid units, e.g. two hearing aid units being adapted to cooperatively provide audible signals to both of the user's ears. Hearing systems may further comprise “auxiliary devices”, which communicate with the hearing aids (units) and affect and/or benefit from the function of the hearing aids (units). Auxiliary devices may be e.g. remote controls, remote microphones, audio gateway devices, mobile phones, public-address systems, car audio systems or music players. Hearing aids and hearing systems may e.g. be used for compensating for a hearing-impaired person's loss of hearing capability, augmenting or protecting a normal-hearing person's hearing capability and/or conveying electronic audio signals to a person.

In the present disclosure, the hearing aid may also include a hearing aid device or listening device or ear protection device that is to be placed, fully or partially, in the ear canal of the user. The hearing aid may thus include any of the in-the-ear (ITE) hearing aids, invisible-in-canal (IIC) hearing aids, completely-in-canal (CIC) hearing aids, deep-in-canal (DIC) hearing aids or the a receiver-in-the-ear (RITE) hearing aid.

The term inserting a hearing aid into the ear canal of the user include insertion of the hearing aid into the desired position in front of the tympanic membrane, in which position the hearing aid is capable of making speech more intelligible for the user and where the hearing aid is capable of correcting the impaired hearing of the user. In the desired position, the hearing aid is neither dangerously deep into the ear canal threatening integrity of the tympanic membrane nor too far away from the tympanic membrane, ensuring improved performance of the hearing aid.

The term withdrawing of the hearing aid from the ear canal include moving the hearing aid from a position within the ear canal to a position outside the ear canal or outside the ear altogether.

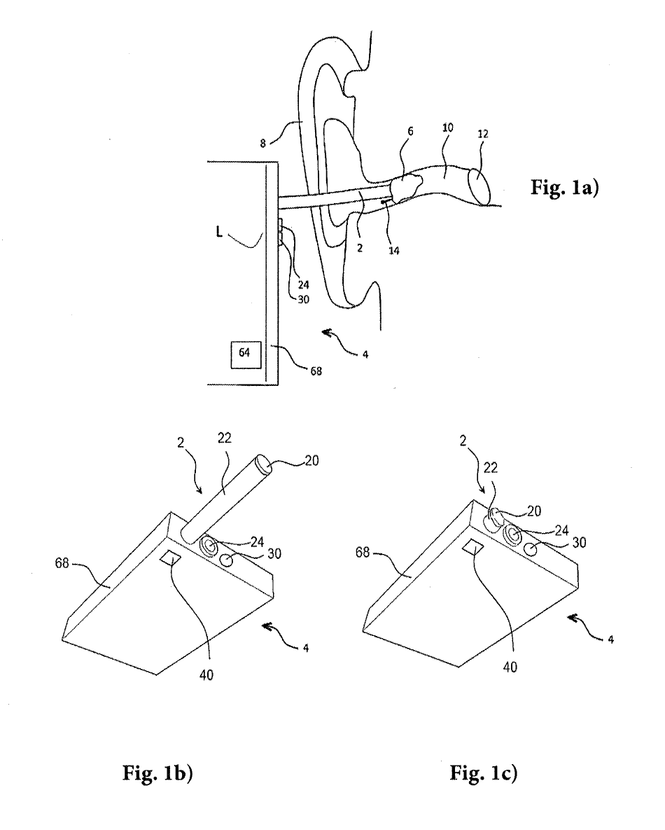

Referring initially to FIG. 1a)-1c), where the FIG. 1a) illustrates schematically a view of the hearing aid (6) being inserted into the ear canal (10) of the user by using a tool (2) comprised by a device (4) with the hearing device (6) at a distance from the tympanic membrane (12) of the user. FIG. 1a) may, however also illustrate a situation in which the hearing aid 6 is being removed from the ear canal 10. The FIG. 1b) illustrates a schematically perspective view of the device (4) with the tool (2) in an extended position; and FIG. 1c) illustrates a schematically perspective view of the device (4) with the tool (2) in an enclosed position.

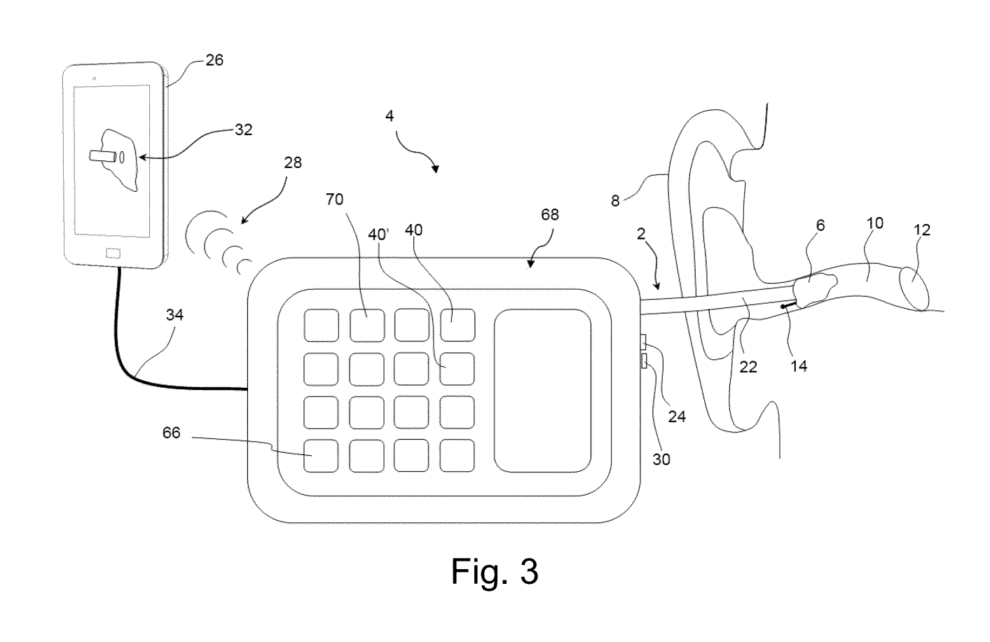

According to an embodiment of the disclosure, a device (4) for inserting a hearing aid (6) into an ear canal (10) of a user of the hearing aid or for withdrawing the hearing aid (6) from the ear canal is disclosed. The device includes a tool (2) adapted to removably attach to the hearing aid (6) for positioning the hearing aid in the ear canal (10), a camera (24) adapted to capture data (32) comprising at least one image and/or video of the ear canal during the insertion or withdrawing of the hearing aid; and a transmitter (64) adapted to transmit the captured data to an external unit (see FIG. 3, 26). The removably attached suggests that the tool (2) is adapted to be attached to and detached from the hearing aid (6). The tool (2) has sufficient strength to push and pull the hearing aid during the insertion and withdrawal of the hearing aid (6). Similarly, the attachment of the tool (2) to the hearing aid (6) has sufficient strength to push and pull the hearing aid during the insertion and withdrawal of the hearing aid (6).

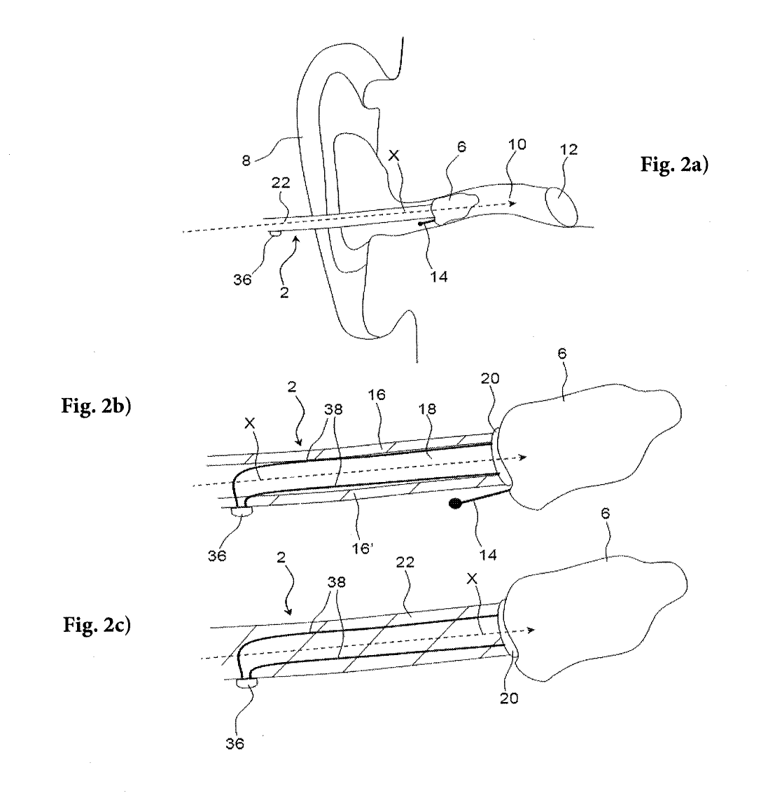

In an embodiment, the device (4) includes a folding means (see FIG. 3, 66 represents a user interface for manually activating the folding means) adapted to collapse the tool (2). The collapse of the tool (2) refers to moving the tool from an extended position (see FIG. 1b) to a position where the tool is no longer inserted into the ear canal such as in an enclosed position (see FIG. 1c). The tool (2) may be collapsed, either manually or automatically, when an axial force applied to the tool (2) during insertion or withdrawing exceeds a predefined level or when the tool (2) is not in use for inserting or withdrawing the hearing aid. The axial force is the force applied in the direction of a longitudinal axis (see FIG. 2, X) and the predefined level is defined as the axial force level that is considered painful to the user and/or dangerously high during the insertion or withdrawal steps. Thus, it is possible to avoid unintended damage to the ear canal or tympanic membrane.

During the inserting or withdrawing the hearing aid, an acceptable deviation limit relative to the predefined level may also be set. Thus, in order to avoid frequent collapse of the tool because of momentary axial force that marginally exceeds the predefined level but is still within the acceptable deviation limit; the tool (2) may include a spring based force absorption mechanism. The spring absorbs the momentary excess axial force and provides feedback such as a haptic feedback to a hearing care profession (HCP)/user, allowing the HCP/user to adjust the axial force such that adjusted applied axial force is within the predefined level. This feature also allows for avoiding unintended damage to the ear canal or tympanic membrane of the user. The applied axial force during the insertion and/or withdrawal is measured and the measured force is transmitted to an external device, which may include a display unit, allowing visual monitored of the applied axial force. The external device may include a storage unit to store the measured axial force for various purposes such as a hearing aid user log, HCP log, user or user population analysis reasons, etc.

In one embodiment, the collapse of the tool (2) is implemented using a retractable mechanism such as a telescopic boom tool having different tool sections where a first section is adapted to be received within a subsequent section such as like a support leg in a tripod stand. The telescopic boom tool is adapted to be extended from and received preferably within a control means (68), which is comprised by the device (4). In an alternative embodiment, the retractable mechanism includes a slidable tool comprising a single section that is adapted to extend out of the control means (68) and is adapted to be received preferably within the control means (68). In yet another alternative embodiment, the collapse may also be implemented using a coilable boom such that the boom retains a longitudinal structure along the longitudinal axis X in the extended position and is coilable, preferably within a control means 68, in the enclosed position. It is important to ensure that stiffness of the tool (2) in extended position, including the interlocking among tool sections (if any), is large enough to provide a controlled movement of the hearing aid (6), during insertion and withdrawal of the hearing aid (6) from the ear canal (10) of the user.

The folding means is thus adapted to move the tool (2) from an extended position (see FIG. 1b) with the tool (2) protruding out of the control means (68), comprised by the device (4), to an enclosed position (see FIG. 1c) with the tool (2) substantially or completely received in the control means, and vice versa. In other words, the folding means is also adapted to move the tool (2) from the enclosed position (see FIG. 1c) with the tool (2) substantially or completely received in the control means to the extended position (see FIG. 1b) with the tool (2) protruding out of a control means (68). The term substantially refers to a scenario where the tool is not completely received in the control means but is received enough to be out of the ear canal of the user or received enough such that the tool is prevented from being damaged when the tool (2) is not in use. The receiving of the tool into the control means (68) of the device (4) may be implemented by having the tool received within a bore (not shown) in the control means (68) of the device (4).

In different embodiments, the tool (2) is either permanently or detachably attached to the device (4). In the detachably attached condition, the device (4) includes a mount (not shown) to accept the tool (2), which is adapted to be attached to the mount. The collapsible feature or the detachably attached tool individually also allow for avoiding damage of the tool (2) when the tool is not in use for insertion or withdrawal of the hearing aid.

In one embodiment, the tool includes a transmission means adapted to transmit the captured data (32) that the camera (24) mounted on the tool capture, from the tool to the external unit (see FIG. 3, 26) and/or the control means (68). The communication link between external unit (see FIG. 3, 26) and/or the control means (68) and the camera (24)/light (30, described later) mounted on the tool allows the external unit and/or the control means to perform at least one of the tasks comprising adjusting camera settings and adjusting light source settings. The control means and/or the external unit may also be adapted to render a help file or device instructions, calculate a transverse length of the tool, calculate the applied axial force, compare the applied axial force with the predefined value for facilitating collapsing of the tool, record in a memory applied axial pressure when the user reports pain during the insertion or withdrawing of the hearing aid, and record in the memory transverse length when the user reports pain during the insertion or withdrawing of the hearing aid. For example, if the external unit is a smartphone, then a mobile application (“app”) may be used to perform any of these tasks.

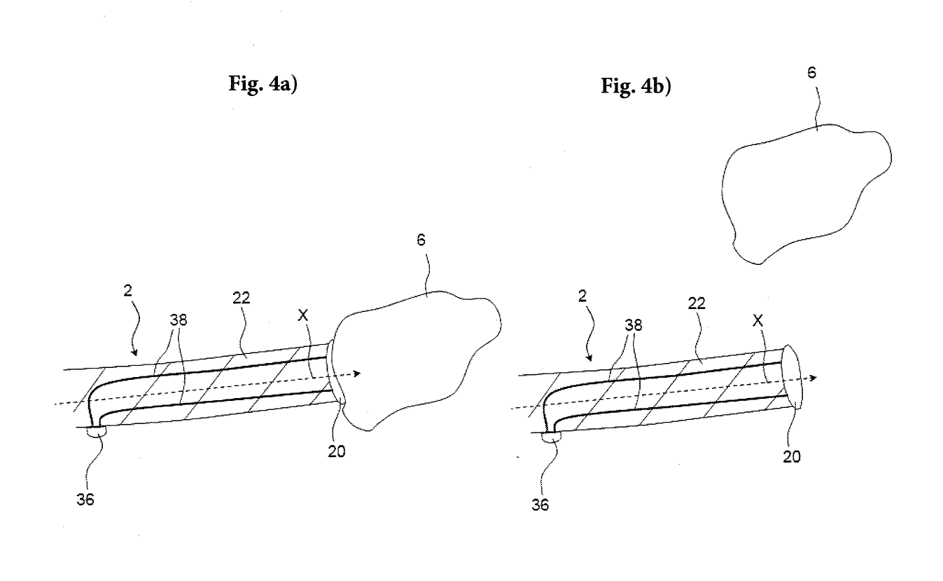

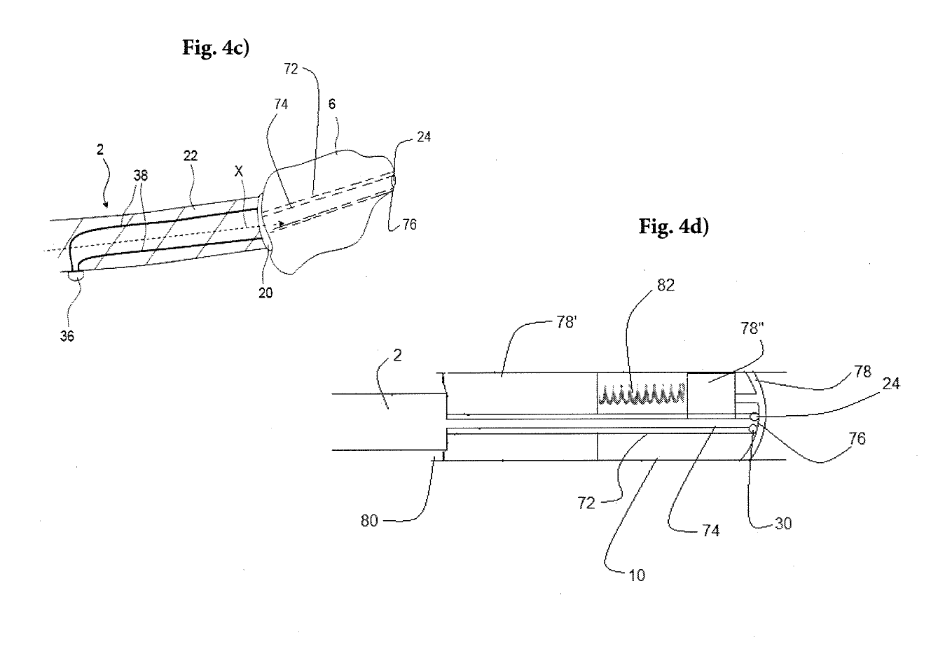

The camera (24) may typically capture the data by passing through a through-going bore (72) in the hearing aid, as illustrated in FIG. 4c. However, other implementations are also conceivable such as illustrated in FIG. 1a. The data (32) captured by the camera (24) may be transmitted to the external unit (26) using a wired connection. However, preferably the data is wirelessly transmitted using a transmitter (64), which may utilize Bluetooth, WIFI or another wireless standard to communication with the external unit (26).

The captured data includes at least one image and/or video of the ear canal. The captured image is typically a two-dimensional image. However, the control means (68) and/or the external unit (26) may be adapted to convert the two-dimensional image sequence into a three-dimensional image for example, by adding a depth value to an image, based on the information available in the two-dimensional image sequence. Conventionally known techniques such as structure from motion (SFM) approach, or depth from cues (DFC) approach may be used. Furthermore, the control means (68) and/or the external unit (26) may further be adapted to adjust at least one or more of brightness, contrast, white balance, sharpness, clarity, color saturation, edge sharpness and other characteristics of the captured image. The captured video may include a video sample comprising only a few steps during the insertion or withdrawal of the hearing aid. The captured video may also include the video capturing all steps during the insertion or withdrawal of the hearing aid. The control means (68) and/or the external unit (26) may also be adapted to enhance the video quality. The recited manipulation of the capture image and/or the video may be performed manually but preferably the external unit and/or control means are adapted to perform such manipulation automatically in real time.

In an embodiment, the control means (68) may further be adapted to compress the data using a compression technique before transmitting the data to the external unit (26) for faster transmission, the external unit (26) may be adapted to decompress the received data, before rendering the decompressed data.

The external unit (see FIG. 3, 26) is adapted to receive the data (32) that the transmitter (64) and/or the transmission means transmits. The external unit and/or the control means (68) may individually include a memory (not shown) to store the data in their respective memory. The external unit (26) is adapted to render the received data through audio-visual means. The external unit may include any of the telephone, smartphone, display unit, computer unit etc. The data is rendered at the external unit (26) in real time during the insertion and withdrawal of the hearing aid. The HCP or in case of self insertion/withdrawals, the user will be able to view the area around the ear canal and the hearing aid during use of the tool. Thus, insertion or withdrawal of the hearing aid into or from the ear canal is greatly facilitated because the user of the tool is assisted and guided in an improved and secure manner. This may also offer the advantage of using the camera to inspect inside of the ear canal as a user-operated otoscope.

In another embodiment, the device includes a light source (30) adapted to illuminate a region of interest of the ear canal (10). The region of interest includes ear canal region that is under investigation during the insertion or withdrawal of the hearing aid. The region of interest may further include regions other than investigation region, for example ear canal region that might be useful to monitor but are not conventionally and directly related to the positioning of the hearing aid in the ear canal. For example, the camera may capture regions that would allow converting a captured two-dimensional image sequence into a three-dimensional image data. The region may typically be illuminated through the through-going bore in the hearing aid, as described earlier where the light is extends through the hearing aid (see FIG. 4d). However, other implementation are also conceivable such as the one illustrated in FIG. 1c.

In comparison to scenario where no such light source is used, the illumination from the light source (30) offers an improved lighting conditions for visual inspection and/or for the camera (24) to capture the data during the insertion or withdrawal of the hearing aid (6). The improved lighting condition, by use of the light source, for the camera allows for capturing higher quality images and/or videos. In this way, the HCP or the user may see the tympanic membrane during insertion and is certain of brining the hearing aid into close proximity of the tympanic membrane without getting dangerously close to the tympanic membrane, thus eliminating hurting the user or damaging the tympanic membrane.

The light source (30) may include a light emitting diode (LED) or any other type of light source that offers a balance between dimensions of the light source (30) relative to the device size/ear canal size and illumination properties of the light source relative to capabilities of the camera (24).

In one embodiment, the camera (24) is permanently or detachably mounted on the control means (68). In another embodiment, the camera (24) may be permanently or detachably mounted on the tool (2). Similarly, in one embodiment, the light source (30) is permanently or detachably mounted on the control means (68). In another embodiment, the light source (24) is permanently or detachably mounted on the tool (2). It is certainly conceivable that these embodiments are combinable. For example, the camera (24) may be mounted permanently on the tool (2) while the light source (30) is detachably mounted on the device (4), or the camera (24) is detachably mounted on the device (4) while the light source (30) is permanently mounted on the device (49). Depending upon the size of camera and/or light source relative to the size of the hearing device and ear canal size; it is conceivable that the camera and/or the light source may be integrated with the hearing aid. In an embodiment, a permanent or detachable camera (24) is mounted on the tool (2). The camera being adapted to capture the data (32) that includes at least one image and/or video of the ear canal (10) during the insertion or withdrawing of the hearing aid (6). The tool, comprising the camera, may also be mounted with a light source (30) that is permanently or detachably mounted on the tool (2) and adapted to illuminate the region of interest of the ear canal (10). Other combinations, lying within the scope of the disclosure, are also possible.

The relative position of the light source (30) and the camera (24) is such that the light source suitably illuminates the region of interest of the ear canal, thus facilitating visual inspection and/or data capturing by the camera (24). In other words, the relative position of the camera and/or light source may be adjusted in order to achieve optimum conditions to assist during insertion and withdrawal of the hearing aid in the ear canal. It may be an advantage that camera and the light source are arranged next to each other, preferably at an end side of the control means (68) or a proximal end of the tool (2). The end side being defined by the side facing the tympanic membrane, as illustrated for the device (4) in FIG. 1(a). The proximal end is the end of the tool (2) that is closer to the tympanic membrane (12) when the hearing aid is inserted into or withdrew from the ear canal. In an embodiment, the camera (24) and/or the light source (30) may be movably attached to the control means (68) e.g. by means of a telescopic means (not shown) that may be collapsed when not in use. Alternatively, the camera (24) and/or the light source may be in a slidable arrangement along a length (L) of the end side of the control means. Thus, the camera 24 and/or light source 30 illustrated in the accompanying figures is only by way of example.

FIG. 1b) and FIG. 1c) illustrate the tool (2) that includes an elongate member (22) having a contact member (20) provided at the proximal end of the tool (2). The contact member (20) is adapted to provide optimum contact/grip to the hearing aid (6), as illustrate in the FIG. 1a).

The elongate member (22) of the tool may be completely inserted/received into the control means (68), when the tool is not in use. Therefore, the tool (2) will not protrude from the surface of the control means (68) when the tool (2) is not in use. In other scenarios, the tool may be substantially received in the control means (68) with only a small portion of the tool protruding out of the control means (see FIG. 1c)). This function makes it possible to automatically move the tool from a hidden position within the remote control to a visible position from which the tool can be used to insertion and removal of a hearing aid into the ear canal.

The tool (2) is adapted to transverse along or substantially along a longitudinal axis (see FIG. 2, X) for positioning the hearing aid (6) in the ear canal (10). This is implemented by applying the axial force on the tool during insertion or withdrawal of the hearing aid. In alternative embodiments, such movement may also be implemented by having the tool that works on the principle of a retractable elongate member (22) or coilable elongate member (22), as discussed earlier. The retractable or coilable elongate member allows for changing the transverse length of the elongate member gradually instead of in steps, thus providing finer control of the movement of the elongate member (22) and the attached hearing aid (6) during the insertion and withdrawal of the hearing aid. The elongate member may consist of several interconnected members that may be maintained in a number of linked connections coupled in series constituting a rod member when operated in one way. The device/tool thus allows for inserting the hearing aid into the ear canal in a simple, secure and easy way. In any of the above embodiments, an auto-translation means (see FIG. 3, 70 represents the user interface for activating the auto-translation means), comprised by the control means (68), may be adapted to gradually transverse the tool automatically along the longitudinal axis (X).

Referring now to FIG. 2a)-2c), wherein the FIG. 2a) illustrates schematically a view of a hearing aid (6) being inserted into the ear canal (10) of the user by using the tool (2) according to an embodiment of the disclosure.

In the FIG. 2a), the tool (2) comprises the elongated member (22) and the hearing aid (6) is attached to the proximal end of the elongate member (22) having the longitudinal axis (X). The proximal end of the tool (2) extends in the ear canal (10) while the distal end (end of the tool away from the tympanic membrane (12) of the tool extends outside the ear (8) of the user. A pull-out string (14) may also be attached to the hearing aid (6). The hearing aid (6) is positioned at a distance from the ear drum (12). The terms proximal and distal are defined in relation to the ear drum 12, i.e. end of the tool proximal or distal to the ear drum.

The hearing aid (6) is attached to the proximal end of the elongate member (22) by means of electroadhesion. In other words, the tool (2) is adapted to attach to the hearing aid (6) through electroadhesion.

The elongate member (22) includes the activation means (36) that is adapted to couple (attach) or decouple (detach) the attachment between the proximal end of the elongate rod (22) and the hearing aid (6). Typically, the activation means (36) is a press button that can be pressed and may be provided at a lateral side of the elongate member 22. However, other implementation mechanisms are also possible such as by providing functionality of the activation means (36) at the control means (68).

The tool (2) comprises an actuation means (only partly illustrated in figures by 38), activated by the activation means (36), that is configured to provide an attachment between the proximal part of the elongate member (22) and a corresponding contact surface of the hearing aid (6).

The FIG. 2b) illustrates schematically a cross-sectional view of the tool (2) being attached to the hearing aid (6). The tool (2) comprises a first wall (16) and a second wall (16′). The first wall 16 and the second wall 16′ in non-sectionalized enclosed situation form a channelled enclosure (18) adapted to include mechanism required for attaching or detaching the tool (2) to/from the hearing aid (6).

The tool (2) is adapted to attach to the hearing aid (6) through electroadhesion. A contact member (20) is provided at the proximal end of the tool (2). The contact member (20) is adapted to provide optimum conditions to achieve a firm attachment of the tool (2) with the hearing aid (6). The longitudinal axis of the tool (2) is represented by the letter X.

The activation means (36), illustrated by a press button (36) as provided at the lateral side of the wall (16′), is activated by pressing; then an electrical connection is made by means of the cables (38) which comprise a part of the actuation means (38) of the tool (2). The actuation means (38) of the tool (2) comprises a part that is integrated in the contact member (20) and hence is not visible. By using the same activation means (36), the tool (2) may be attached or detached to/from the hearing aid (6).

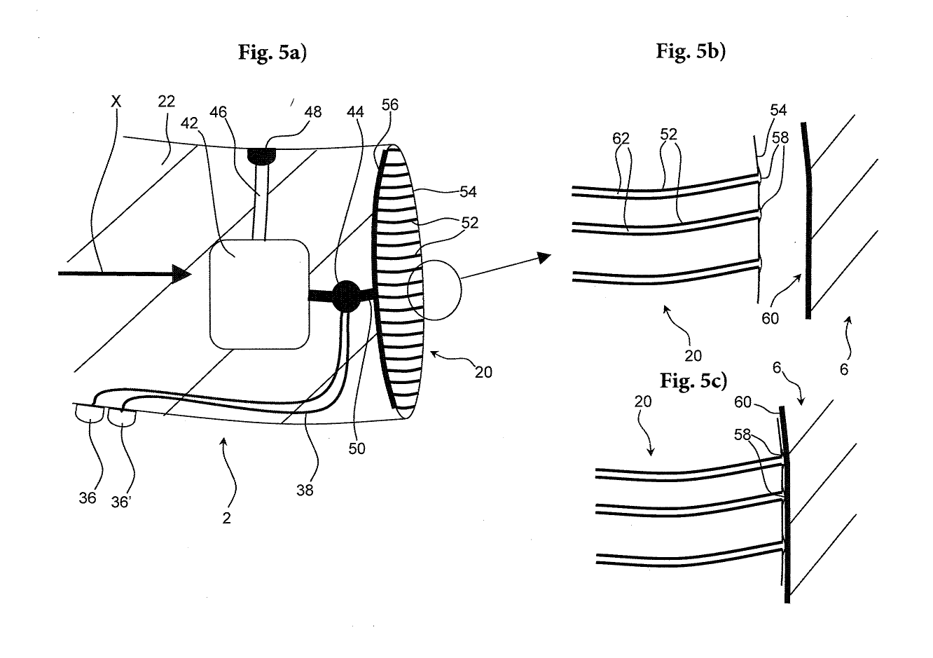

Thus, according to another embodiment of the disclosure, the tool (2) for inserting the hearing aid (6) into the ear canal (10) of the user of the hearing aid and for withdrawing the hearing aid (6) from the ear canal is disclosed. The tool (2) includes an activation means (36) adapted to actuate attachment means (20, 38) for removably attaching the tool (2) to the hearing aid through electroadhesion. The details relating to the electroadhesion means are described later with reference to the FIG. 5.

FIG. 2c) illustrates schematically a cross sectional view of the tool (2) being attached to the hearing aid (6) according to an embodiment of the disclosure. The tool (2) comprises the elongate member (22) that is attached to the hearing aid (6). The contact member (20) is provided at the proximal end of the tool (2) in order to provide a secure attachment of the hearing aid (6) to the tool (2).

The elongate member (22) of the tool (2) comprises the activation means (36), as illustrated at the outer periphery of the elongate member (22). By activating the activation means (36), such as by way of pressing the press button 36, the actuation means (38) integrated with the tool (2) is actuated. The hearing aid (6) is detached from the proximal end of the elongate member (22) of the tool either by pressing the activation means (36) or by pressing a release press button (not shown).

FIG. 3 illustrates schematically a view of the hearing aid (6) being inserted into the ear canal (10) of the user by means of the tool (2) comprised by the device (4), while data is captured by the camera (24) and is transmitted to the external unit (26) according to an embodiment of the disclosure. The captured data (32), i.e. at least one image and/or video are sent to the external unit (26) such as a smartphone either wirelessly by a wireless signal (28) e.g. by using WIFI, Bluetooth or another standard for wireless communication or by a wired connection (34).

The control means (68) of the device (4) includes a user interface (40, 40′), which is adapted to attach the tool (2) to the hearing aid (6) and to detach the tool (2) from the hearing aid (6). This is performed by using the user interface (40, 40′) to activate (using 40) or deactivate (using 40′) the elongate member (22) of the tool (2). The user interface (40, 40′) may include press buttons and/or touch screen, that activates the actuation means (partly represented by 38, see FIG. 2) of the tool (2). This causes attachment or detachment of the proximal end of the rod member (22) of the tool (2) with the hearing aid (6). In essence, the user interface (40, 40′) includes same functionality as the activation means (36). In an embodiment, the same user interface (40 or 40′) may be adapted for attachment and detachment purposes. The option of providing the attachment and detachment functionality at the control means might be beneficial from an ergonomic point of view. This may also be useful, once the hearing aid is correctly placed at the desired position in the ear canal of the user because using the activation means of the tool to detach the tool from the hearing aid might move, at least slightly, the correctly placed hearing aid.

Thus, the user interface (40, 40′) and/or the activation means (36) may be individually adapted to be used to detach the hearing aid (6) from the rod member (22) of the tool (2) either when the hearing aid (6) has been placed correctly at a desired position in the ear canal (10) of the user or when the hearing aid (6) has been removed from the ear canal (10).

Thus, in one embodiment, the device (4) that includes the user interface (40, 40′), comprised in the control means (68), adapted to attach the tool (2) to the hearing aid (6) and to detach the tool (2) from the hearing aid (6). In another embodiment, the tool includes the activation means (36) adapted to attach the tool (2) to the hearing aid (6) and to detach the tool (2) from the hearing aid (6). In yet another embodiment, both the control means (68) includes the user interface (40, 40′) and the tool includes the activation means (36), which are individually adapted to attach the tool (2) to the hearing aid (6) and to detach the tool (2) from the hearing aid (6).

The FIG. 4a) illustrates how the tool (2) is attached to the hearing aid (6) and the FIG. 4b) illustrates how the tool (2) is detached from the hearing aid (6) according to an embodiment of the disclosure. The FIG. 4a) corresponds to the FIG. 2c) and illustrates that the tool 2 is capable of keeping the hearing aid 6 attached to the tool 2. In FIG. 4b), however; the activation means (36) is activated (by pressing for a press button illustration) in order to detach the hearing aid 6 from the tool 2. In another embodiment, this may be implemented by using the user interface (see FIG. 3, 40′) of the control means (68).

The activation means (36) may be used both to activate the electroadhesion between the tool (2) and the hearing aid (6) (in FIG. 4a) and afterwards (in FIG. 4b) to detach the hearing aid (6) from the tool (2). It is also possible and may be an advantage to apply a first activation means to provide attachment of the hearing aid (6) to the tool (2) and a second activation means to detach the hearing aid (6) from the tool (2). This will be comparable to the embodiment where the control means (68) attaches and detaches the tool (2) to/from the hearing aid (6) using the user interface (40) for attachment and the user interface (40′) for detachment.

Thus, the user interface (40, 40′) comprised in the control means (68), and/or the activation means (36) comprised in the tool (2) may be individually adapted to attach the tool (2) to the hearing aid (6) and to detach the tool (2) from the hearing aid (6).

In several embodiments, the control means (68) is adapted to perform at least one of the tasks comprising adjusting camera settings, adjusting light source settings, rendering a help file or device instructions, calculating a transverse length of the tool, calculating the applied axial force, comparing the applied axial force with the predefined value, recording in a memory applied axial pressure when the user reports pain during the insertion or withdrawing of the hearing aid, and recording in a memory transverse length when the user reports pain during the insertion or withdrawing of the hearing aid. Adjusting the camera setting such as aperture size/shutter speed or light source setting such as brightness allows for capturing improved data. Calculating and storing transverse length and applied axial force across a user group may allow for maintaining log data for analysis purposes and in relation to an individual user, provides reliable reference for future insertion or removal.

Recording the transverse length and applied axial force in relation to user reported pain also allows for reliable axial force and transverse length reference for a specific user and for analysis purpose across a user group. Comparing the applied axial force with the predefined value facilitates collapsing of the tool. Rendering help file facilitates training of the user or the HCP in a systematic manner and for troubleshooting purposes during the user of the device. It is conceivable that other implementation utilizing processing and storage capabilities of the control means (68) is within the scope of the disclosure.

FIG. 4c) illustrates a through-going bore according to an embodiment of the disclosure and FIG. 4d) illustrates an ear lens type hearing aid according to an embodiment of the disclosure.

The camera (24) may typically capture the data and/or the light source (30) may illuminate the region by adapting the camera and/or the light source pass through the through-going bore (72) in the hearing aid. The tool may include a thin rod (74) adapted to extend through the hearing aid and having the camera at a tip (76) of the rod, the tip facing the tympanic membrane (12). The through-going bore may include hearing aid vent(s) that is provided for overcoming occlusion problem. In order to provide better illumination for data capturing, the tool comprises a light source (30) which is adapted to extend through the through-going bore (72) of the hearing aid. The through-going bore for the light source may be different from the through-going bore used for the camera (24). The light source (30) may be connected to the tip or along the length of the thin rod (74). The light source may also be positioned diagrammatically opposite to the camera (24) at the thin rod, as illustrated in FIG. 4d. To be able to see the tympanic membrane during insertion is especially important in the hearing aid for placing the hearing aid in desired position and avoiding any unintended damage to the tympanic membrane. This is particularly important for ear lens type hearing aids (78″), where sound signals are transmitted by a physical contact member via induction to a magnetic receiver mounted on the tympanic membrane or to middle ear bones. Such an arrangement is illustrated in FIG. 4d.

Now referring to FIG. 4d, the hearing aid (6) may include two interlinked parts (78′ and 78″), one part (78′) sitting close to the ear canal entrance (80, distal to the tympanic membrane 12) and the other part (78″) sitting close/proximal to the tympanic membrane. In this scenario, a relatively stiff connection between the two parts is desired while inserting the hearing aid in the ear canal (10). Whereas, when the hearing aid is in use by the user, the two parts (78′ and 78″) should preferably be freely moveable with respect to each other. Extending the camera (24) and/or the light source (30) through through-going bore in both parts (78′ and 78″), as seen in FIG. 4d, during insertion, allows the then thin tube (74) to keep the two hearing aid parts stiffly connected as desired during insertion while the captured data will assist the user to correctly position the hearing aid. After insertion, the thin tube is extracted and the two parts (78′ and 78″) are well seated in the ear, and a flexible connection (82) between the two parts allows for movement of the two parts with respect to each other such as movements caused by jaw bone excitation. For example, the part (78″) closer to the tympanic membrane is fixedly/substantially fixedly secured in its position while the part (78′) is moveable with respect to the part (78″) because of the flexible connection (82) during day-to-day use of the hearing aid. FIG. 5a) illustrates a schematically cross-sectional view of a proximal portion of the tool according to an embodiment of the disclosure. The tool (2) includes the elongate member (22), which is preferably a solid cylindrical rod. The elongate member (22) includes the contact member (20), made of a resilient material, at the proximal end. The resilient material allows the contact member (20) to adjust and fit to the shape of a contact surface (60) of the hearing aid (6), when the contact member (20) is brought in contact with the hearing aid (6). Alternatively or additionally, the contact member (20) may include a geometry that fits the geometry of the hearing aid. In this way, it is possible to achieve a good and firm contact between the hearing aid (6) and the contact member (20) of the tool (2).

The contact member (20) comprises a plurality of channels (52). The plurality of channels (52) extend usually parallel or substantially parallel to the longitudinal axis X of the elongate member (22). The plurality of channels (52) are connected to a common distribution member (56). The common distribution member (56) is further connected to a liquid reservoir (42) through an outlet pipe (50). The liquid reservoir (42) may be filled with liquid, such as water, through an inlet pipe (46) by removing a cover (48) that constitute a closure of the inlet pipe (46).

A liquid pump (44) is mounted at the outlet pipe (50) and is adapted to pump the liquid from the liquid reservoir (42) through the outlet pipe (50) and further through the distribution member (56) and through the channels (52) to an outside of a contact surface (54) of the contact member (20). Thus, the liquid reservoir (42) is adapted to contain liquid and is arranged in such a manner that liquid may be pumped from the liquid reservoir (42) to the outside surface of the contact surface (54).

In an embodiment, the elongate member (22) includes the activation means (36, 36′), typically in the form of a first button (36) arranged next to a second button (36′) at the lateral side of the elongate member (22). The activation means are accessible to the HCP/user when the tool is in use. The activation means (36, 36′) are electrically connected to the pump (44) through a cable connection (38). The activation means (36, 36′) may include means for controlling the pump (44). The pump (44) may be electrically driven by electric power provided by a battery (not shown). Thus, the tool includes the battery providing electrical energy to provide the attachment of the hearing aid to the tool and to detach the hearing aid from the tool. The activation means (36) is used during attachment of the tool (2) to the hearing aid (6), while the activation means (36′) is used to detach the tool (2) from the hearing aid (6). By using the same activation means (36) and/or user interface (40, 40′), an electrical attachment means including (20, 36, 38) for attaching the tool (2) to the hearing aid (6) by means of electroadhesion is actuated. The battery provides adequate voltage for the operation of the electroadhesion means.

FIG. 5b) illustrates a close-up view of the tool (2) shown in FIG. 5a) arranged next to the hearing aid (6) having a contact surface (60) of the hearing aid (6) facing the contact surface (54) of the contact member (20). It may be seen that the channels (52) extend parallel or substantially parallel to one another. The channels (52) include an open end provided at the contact surface (54) of the contact member (20) of the tool (2).

The liquid (62), present in the channels (52), is pumped onto the contact surface (54) of the contact member (20). Accordingly, a plurality of separated liquid portions (58) are provided along the contact surface (54) of the contact member (20).

It is important that the plurality of liquid portions (58) provided along the contact surface (54) are separated with a minimum distance and the liquid portions (58) are not brought into contact with one other. In this way, the surface tension from each liquid portion of the plurality of liquid portions (58) is maintained and thus a large resulting force (attraction) between the tool (2) and the hearing aid (6) may be achieved.

FIG. 5c) illustrates a close-up view of the tool (2) shown in FIG. 5a) being attached to the contact surface (60) of the hearing aid (6).

The tool (2) is attached to the hearing aid (6) by bringing the contact surface (54) of the contact member (20) of the tool (2) into contact with the contact surface (60) of the hearing aid (6). The pump (44) is used to pump the liquid (62) from the liquid reservoir (42) to the contact surface (54) and provides a plurality of separated liquid portions (58) along the contact surface (54). Each of these separated liquid portions (58) creates an attractive force between the contact surface (54) of the contact member (20) and the contact surface (60) of the hearing aid (6).

Detachment of the tool (2) from the hearing aid (6) may be provided either by pumping liquid back (away) from the contact surface (54) of the contact member (20), by pumping more liquid (62) onto the surface (54) of the contact member (20) and hereby reducing the surface tension and thus the attachment force. It is also possible to provide mechanical detachment means.

There may be arranged control valves (not shown) in order to avoid more than the intended quantity of liquid (62) being provided onto the surface (54) of the contact member (20).

In view of the above description, it is evident that the tool (2) a least comprises an elongate member (22), a contact member (20) and means (42, 44, 50, 52, 54, 56) for providing a plurality of separated liquid portions (58) onto an outside surface (54) of the contact member (20), the contact member (20) being adapted to removably attach to a contact surface (60) of the hearing aid (6). Said means include electroadhesion means for allowing attachment or detachment of the tool (2) to/from the hearing aid (6).

It should be appreciated that reference throughout this specification to “one embodiment” or “an embodiment” or features included as “may” means that a particular feature, structure or characteristic described in connection with the embodiment is included in at least one embodiment of the disclosure. Therefore, it is emphasized and should be appreciated that two or more references to “an embodiment” or “one embodiment” or “an alternative embodiment” or features included as “may” in various portions of this specification are not necessarily all referring to the same embodiment. Furthermore, the particular features, structures or characteristics may be combined as suitable in one or more embodiments of the disclosure.

Throughout the foregoing description, for the purposes of explanation, numerous specific details such as a push button for the activation means, an illustrative smartphone as the external unit, etc. were set forth in order to provide a thorough understanding of the disclosure. It will be apparent, however, to one skilled in the art that the disclosure may be practiced without some of these specific details.

Accordingly, the scope of the disclosure should be judged in terms of the claims which follow.

1. A device for inserting a hearing aid into an ear canal of a user of the hearing aid for withdrawing the hearing aid from the ear canal, the device comprising
a tool adapted to removably attach to the hearing aid for positioning the hearing aid in the ear canal;
a camera adapted to capture data comprising at least one image and/or video of the ear canal during the insertion or withdrawing of the hearing aid; and
a transmitter adapted to transmit the captured data to an external unit.

2. The device according to claim 1, further comprising a folding means adapted to collapse the tool
when an axial force applied to the tool during insertion or withdrawing exceeds a predefined level; or
when the tool is not in use for insertion or withdrawing.

3. The device according to claim 1, wherein the folding means is adapted to move the tool from an extended position with the tool protruding out of a control means, comprised by the device, to an enclosed position with the tool substantially or completely received in the control means, and vice versa.

4. The device according to claim 1, further comprising a light source adapted to illuminate a region of interest of the ear canal.

5. The device according to claim 1, wherein
the camera is permanently or detachably mounted on the control means and/or on the tool; and/or
the light source is permanently or detachably mounted on the control means and/or on the tool.

6. The device according to claim 1, wherein the tool is adapted to transverse along or substantially along a longitudinal axis for positioning the hearing aid in the ear canal.

7. The device according to claim 1, wherein the tool is adapted to attach to the hearing aid through electroadhesion.

8. The device according to claim 1, wherein the tool comprises an elongate member, a contact member and means for providing a plurality of separated liquid portions onto an outside surface of the contact member, the contact member being adapted to removably attach to a contact surface of the hearing aid.

9. The device according to claim 1, further comprising
a user interface (40, 40′) comprised in the control means, and/or an activation means comprised in the tool being individually adapted to attach the tool to the hearing aid (6) and to detach the tool from the hearing aid, and
the tool being permanently or detachably attached to the device.

10. The device according to claim 1, wherein the control means is adapted to perform at least one of the tasks comprising adjusting camera settings, adjusting light source settings, rendering a help file or device instructions, calculating a transverse length of the tool, calculating the applied axial force, comparing the applied axial force with the predefined value, recording in a memory applied axial pressure when the user reports pain during the insertion or withdrawing of the hearing aid, and recording in a memory transverse length when the user reports pain during the insertion or withdrawing of the hearing aid.

11. A tool for inserting a hearing aid into an ear canal of a user of a hearing aid and for withdrawing the hearing aid from the ear canal, the tool comprising an activation means adapted to actuate attachment means for removably attaching the tool to the hearing aid through electroadhesion.

12. The tool according to the preceding claim 11, wherein the tool is adapted to transverse along or substantially along a longitudinal axis for positioning the hearing aid in the ear canal.

13. The tool according to claim 11, wherein the tool comprises an elongate member, a contact member and means for providing a plurality of separated liquid portions onto an outside surface of the contact member, the contact member being adapted to removably attach to a contact surface of the hearing aid.

14. The tool according to claim 11, further comprising
a permanent or detachable camera mounted on the tool adapted to capture data comprising at least one image and/or video of the ear canal during the insertion or withdrawing of the hearing aid; with or without a light source that is permanently or detachably mounted on the tool and adapted to illuminate a region of interest of the ear canal; and/or
a transmission means adapted to transmit the captured data to an external unit and/or to a control means.

15. The tool according to claim 11, wherein the control means and/or the external unit such as a smartphone is adapted to perform at least one of the tasks comprising adjusting camera settings, adjusting light source settings, rendering a help file or device instructions, calculating a transverse length of the tool, calculating the applied axial force, comparing the applied axial force with the predefined value, recording in a memory applied axial pressure when the user reports pain during the insertion or withdrawing of the hearing aid, and recording in a memory transverse length when the user reports pain during the insertion or withdrawing of the hearing aid.

16. The device according to claim 2, wherein the folding means is adapted to move the tool from an extended position with the tool protruding out of a control means, comprised by the device, to an enclosed position with the tool substantially or completely received in the control means, and vice versa.

17. The device according to claim 2, further comprising a light source adapted to illuminate a region of interest of the ear canal.

18. The device according to claim 3, further comprising a light source adapted to illuminate a region of interest of the ear canal.

19. The device according to claim 2, wherein
the camera is permanently or detachably mounted on the control means and/or on the tool; and/or
the light source is permanently or detachably mounted on the control means and/or on the tool.

20. The device according to claim 3, wherein
the camera is permanently or detachably mounted on the control means and/or on the tool; and/or
the light source is permanently or detachably mounted on the control means and/or on the tool.
